(19) United States
(12) Patent Application Publication
(10) Pub. No.: US 2003/0031311 A1
(43) Pub. Date: Feb. 13, 2003

(54) System and method for blocking data transmissions

(76) Inventor: Larry Louis Menesses, Folsom, LA (US)

Correspondence Address: MICHAEL D. CARBO, P.L.C., 228 St. Charles Avenue, Suite 700, New Orleans, LA, 70130, US

(21) Appl. No.: 10/180,623

(22) Filed: Jun. 26, 2002

Related U.S. Application Data
(60) Provisional application No. 60/301,074, filed on Jun. 26, 2001.

(51) Int. Cl. H04M 1/00; H04M 3/00

(52) U.S. Cl. 379/377

(57) ABSTRACT

An apparatus and method for blocking or disrupting data being transmitted over an analog telephone line, the method including detecting single-frequency carrier tones and then opening the line for a predetermined time to disrupt modem synchronization and thereby blocking or disrupting data transmission, and the apparatus including a line-sensing circuit, an operational amplifier acting as input stages to the line sensing circuit, means for detecting a single-frequency carrier tone on the line, a relay for disconnecting the line when a single-frequency tone is detected, and a switch for selecting the disconnect time period.

### CROSS-REFERENCE TO RELATED APPLICATIONS

This application is a continuation-in-part of U.S. Provisional Application No. 60/301,074, filed Jun. 26, 2001. To the extent not otherwise contained herein, applicant incorporates by reference U.S. Provisional Application 60/301,074, a copy of which is attached hereto as appendix A.

### COPYRIGHT STATEMENT

Not applicable.

### FEDERAL RESEARCH STATEMENT

Not applicable.

### BACKGROUND OF THE INVENTION

1. Field of Invention

The present invention relates generally to systems, apparatus, and methods for blocking data transmissions on analog transmission lines, and more particularly to a system, apparatus, and method for detecting a carrier tone and blocking data transmission on a telephone transmission line for a set period of time after detection of the carrier tone.

When the Internet began becoming popular with the business traveler, hotel and motel owners at first were required to add a few more lines to their telephone systems to accommodate Internet access through the portable computers of guests and staff. As more and more business travelers used portable or laptop computers with modems, it became necessary to double or even triple the amount of lines in the hotels and motels. As the popularity of the Internet and email grew, even non-business travelers increasingly carried laptop computers for accessing email and the World Wide Web, among other uses. Since most Internet service providers use an “800” number or a local telephone number for access, hotel and motel owners bear all of the line cost with no meaningful chance to recover costs associated with usage.

Recently, within the past few years, a trend in the hotel-motel market has been for hotel-motel owners to bear the cost of installing a high-speed local area network (“LAN”) connection to each room. This gives the travelers access to the Internet without tying up the voice grade lines. An obvious problem is the expense of installation and wiring to all of the rooms. Added to the cost of the many hubs and computers required for high-speed Internet access is the cost of the high speed line, T1, DSL, etc. Decisions must also be made about whether to add even more equipment to meter usage and bill the customers for the high-speed Internet access or to give the service away free as a drawing card to the hotel or motel.

To be able to access the Internet even when a high-speed LAN connection is provided, portable computers in a hotel or motel room must have an Ethernet card or a comparable feature installed or connected. If many Internet-access or email access devices do not have the capability for high-speed access, then the high-speed connections will be underused and cost recovery based on metered usage will be unavailable or too expensive. Many Internet and email users will continue to connect to voice grade lines via modems whether or not a high speed LAN is provided. The hotel-motel owner must decide whether to provide, at no cost to the user, another set of lines to be used by his “modem only” laptop customers.

Thus, there is a need for PBX telephone suppliers to improve PBX technology to take advantage of advances in computer technology. Even as these two separate technologies converge, advances on the computer side outpace advances in the telephone industry, which is why so many adjunct pieces and parts are on the market for PBX systems.

Even if a hotel-motel owner were to install a high-speed Internet access LAN and a separate set of lines for modem access, a customer can still connect his portable computer's modem to the motel's line and dial out. A data restrictor can prevent this. An effective data restrictor or blocker could serve not only in the hotel-motel environment, but also in many other instances where data over voice lines is neither wanted nor permitted.

2. Description of Related Art

Conventional methods for stopping transmission of data over voice lines include: (1) clamping or opening the line for enough time for the telephone company or private branch exchange switch to drop the connection; (2) inducing onto the line a tone that spoils the transmitted data as it is presented to the far end modem; and (3) increasing or decreasing the actual line level to a point where data cannot be efficiently transmitted over it.

Data is transmitted most efficiently in the same frequency range as normal voice transmission (300 Hz-3,000 Hz). Some voice frequencies may go slightly below or above this range. Call waiting tones can disrupt data transmissions, especially for modems that do not correct for errors.

Most methods for blocking data over an analog line determine some property associated with the data that is being transmitted, typically pornography or spam, and then discontinue or block access to the requested data transmission. U.S. Pat. Nos. 5,835,722 and 6,065,056 to Bradshaw, et al. describes a system for blocking the use and transmission of material over the Internet based upon the type of material attempted to be transmitted. U.S. Pat. No. 4,888,796 to Olivo, Jr. discloses a program material screening device used with certain apparatus, such as a telephone, to automatically answer and selectively prevent reception and replay of unwanted transmissions. U.S. Pat. No. 6,044,402 to Jacobson et al. discloses a network connection block for blocking unwanted connections. U.S. Pat. No. 5,717,752 to Whitney discloses a data access arrangement provided with a controller having a conducting state and a blocking state. Finally, U.S. Pat. No. 3,459,809 discloses a device for selectively connecting a data phone to a telephone communication network.

None of these prior art references discloses blocking data on an analog line for a set period of time after detection of a carrier tone.

### SUMMARY OF INVENTION:

It is an object of this invention to provide an apparatus to be placed between one or more incoming analog lines and either a PBX system or a home telephone system to monitor signals that pass therebetween, detecting single frequency (i.e., carrier) tones, and using switches to open the line for a preset period of time in order to disrupt modem synchronization and thereby block data transmission.

It is yet another object of this invention to provide a method for blocking or disrupting modem synchronization by use of apparatus according to the invention.

### BRIEF DESCRIPTION OF THE DRAWINGS

FIG. 1 is front view of a data blocking apparatus according to an embodiment of the invention.

FIG. 2 is a schematic diagram of a line sensing circuit and a disconnect circuit of the method and apparatus according to an embodiment of the present invention.

FIG. 3 is a schematic diagram of a carrier tone detecting circuit, disconnect timing select switches, line status indicators, and a power supply circuit according to an embodiment of the present invention.

### DETAILED DESCRIPTION OF THE INVENTION

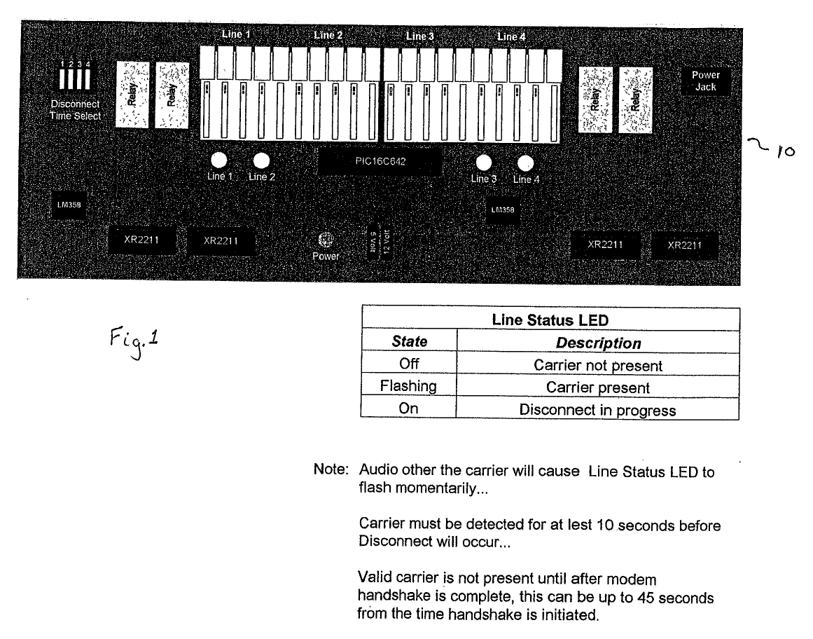

Reference is made to FIG. 1, which is an elevation view of the front panel of data blocking apparatus 10 according a preferred embodiment of the invention. Data blocking apparatus 10 preferably includes connections for four incoming analog lines, four line sensing integrated circuits (XR2211), two operational amplifiers (LM358), which are input stages to the line sensing circuit, four line status indicators, an integrated circuit (PIC16C642) for detecting a single frequency carrier tone on a line, four relays for disconnecting the analog lines when a single frequency tone is detected, four switches for selecting disconnect time periods, five volt and twelve volt transformers, a transformer input (power jack), and a power switch.

Data blocking apparatus 10 as shown has the capability of connecting between up to four analog incoming lines and a PBX system or a conventional telephone system.

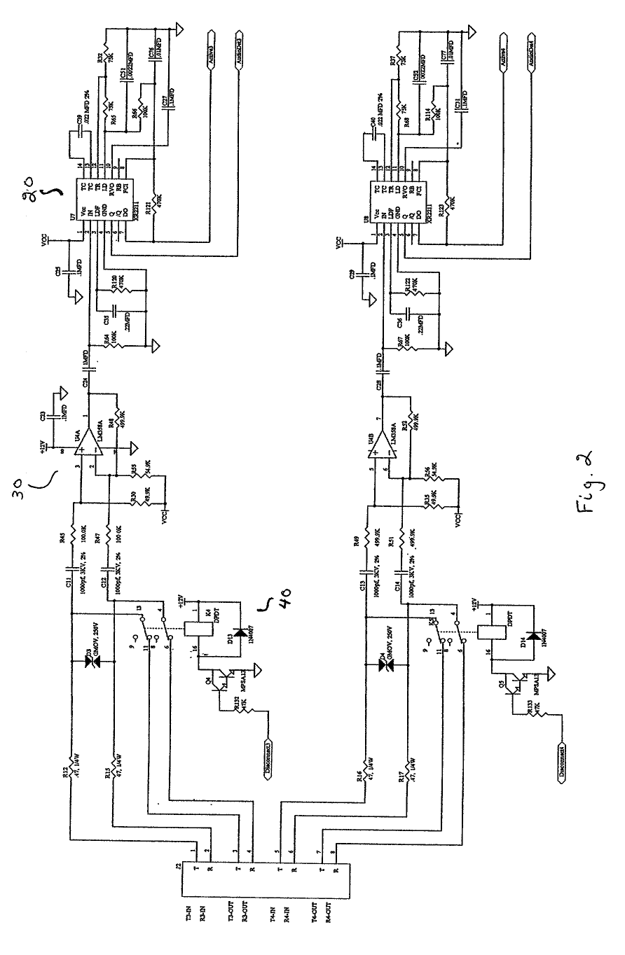

FIG. 2 shows block J2 representing two incoming analog lines (line 3 and line 4). Each analog line has incoming and outgoing segments. Additional incoming lines can be similarly blocked.

Line sensing circuit 20, preferably comprising a 14 dual inline pin integrated circuit, is connected to an incoming line by means of electronic circuitry including operational amplifier 30. When line sensing circuit 20 senses an off-hook condition of a modem or other telephone system, connected either directly to a PBX or other telephone system or connected through a telephone or other analog device to the PBX or other telephone system, monitoring is commenced.

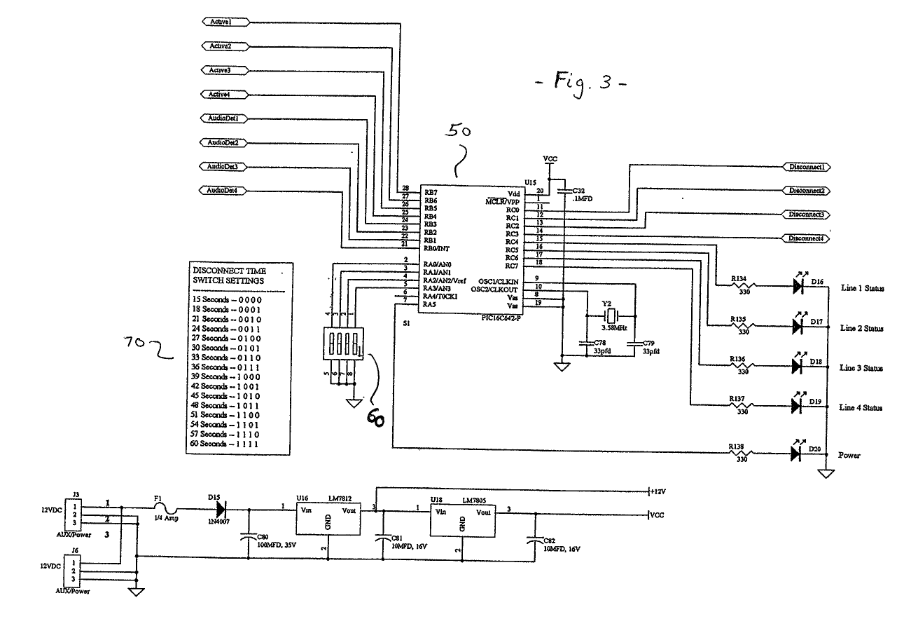

Reference is made to FIG. 3, in which is shown a schematic of integrated circuit 50, which comprises an oscillator to search for and detect single frequency tones of greater than approximately ten seconds in duration. Disconnect time switches are connected to this integrated circuit so that disconnect switch times can be preset in accordance with the settings 70 shown in the tabling listing in FIG. 3.

When a single frequency tone is detected for longer than an approximately ten second duration, a signal is sent to disconnect circuit 40 associated with the line on which the single frequency tone was detected. Disconnect circuit 40 actually opens the normally closed return segment of the line for the duration preset into the disconnect time select switch 60.

The invention may be embodied in other specific forms without departing from the spirit and scope or the essential characteristics thereof. The present embodiment is, therefore, to be considered in all respects as illustrative and not restrictive, the scope of the invention comprising a method, apparatus, and system for blocking data on an analog line for a set period of time after detection of a carrier tone of specified duration.

1. A method for blocking or disrupting data transmission on an analog transmission line in the electrical circuit of a telephone system, comprising the steps of:
detecting the presence of a single-frequency tone that is longer than approximately ten seconds in duration being transmitted along the transmission line, and
disrupting the electrical circuit upon detecting the tone.

2. The method according to claim 1, further comprising the steps of:
sensing an off-hook condition of the telephone system, and commencing monitoring of the system to search for the presence of the single-frequency tone.

3. The method according to claim 2, wherein the monitoring step is accomplished by means of an oscillator.

4. The method according to claim 1, wherein the disrupting step comprises opening a normally closed return segment of the transmission line for a selected duration.

5. The method according to claim 4, wherein the selected duration is preset by means of a disconnect time-select switch.

6. An apparatus for blocking or disrupting data transmission on an analog transmission line, comprising:
line-sensing means connected to an incoming transmission line of a telephone system, the line-sensing means being capable of sensing an off-hook condition of the telephone system;
means for detecting on the transmission line the presence of a single-frequency tone that is longer than a pre-selected duration; and
means for disrupting the transmission line on which the single frequency tone is present.

7. The apparatus according to claim 6, wherein the line-condition sensing means, which comprises a 14-pin dual inline integrated circuit, is connected to the incoming line by means of electronic circuitry comprising an operational amplifier.

8. The apparatus according to claim 6, wherein the line detecting means comprises an oscillator.

9. The apparatus according to claim 6, wherein the disrupting means comprises a disconnect circuit that opens a normally-closed return segment of the line for a selected duration.

10. The apparatus according to claim 9, wherein the selected duration is present into a disconnect time select switch connected to the disconnect circuit.

11. The apparatus according to claim 6, wherein the pre-selected duration is approximately ten seconds.
